(19) United States
(12) Patent Application Publication
(10) Pub. No.: US 2026/0307549 A1
(43) Pub. Date: Oct. 8, 2026

(54) METHOD FOR REDUCING KINETOSIS-RELATED EFFECTS ON AN OCCUPANT ON A VEHICLE SEAT

(71) Applicant: MERCEDES-BENZ GROUP AG, Stuttgart (DE)

(72) Inventors: Gudrun SCHÖNHERR, Holzgerlingen (DE); Valentin BUSS, Stuttgart (DE); Jonas David GLIMMANN, Stuttgart (DE); Felix SCHÜSSEL, Stuttgart (DE)

(21) Appl. No.: 19/120,428

(22) PCT Filed: Sep. 18, 2023
(86) PCT No.: PCT/EP2023/075622

§ 371 Date: Apr. 11, 2025

(30) Foreign Application Priority Data
Oct. 12, 2022 (DE) 10 2022 003 756.4

(51) Int. Cl. B60N 2/02; B60N 2/00; B60N 2/56; B60W 40/08; B60W 50/00; B60W 50/14; B60W 50/16

(52) U.S. Cl. CPC B60N 2/0273; B60N 2/0022; B60N 2/5692; B60W 40/08; B60W 50/0098; B60W 50/16; B60W 2040/0872; B60W 2050/0083; B60W 2050/146; B60W 2540/221

(57) ABSTRACT

A method for reducing kinetosis-related effects on an occupant on a vehicle seat in a motor vehicle is provided. At least one sequence of measures for targeted sensory stimulation of the occupant is initiated at the latest when a kinetosis-related effect of the occupant is detected. The occupant is moved into a seat position leaning on a backrest of the vehicle seat, in which a head of the occupant is held in a specified support position by a headrest of the vehicle seat. The occupant is partially subjected to a cooling treatment by a cooling device of the vehicle seat, at least one sensory stimulation is carried out on at least one stimulation point, and a journey of the motor vehicle is simulated depending on the detected kinetosis-related effects by stimulation elements of the vehicle seat.

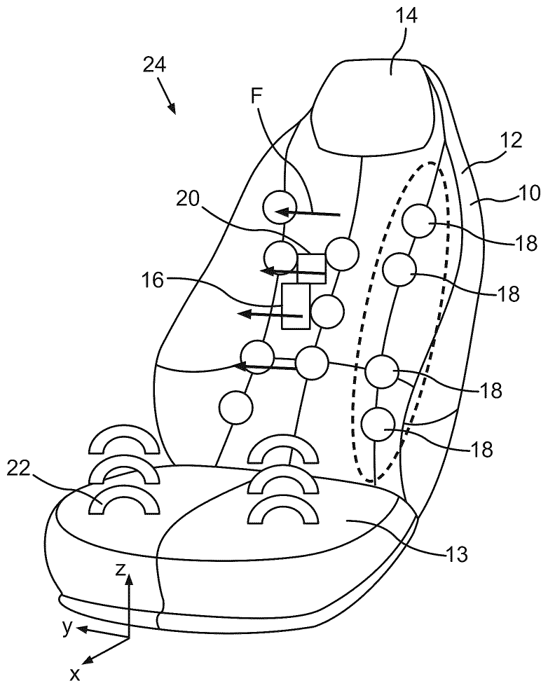

### BACKGROUND AND SUMMARY OF THE INVENTION

Exemplary embodiments of the invention relate to a method for reducing kinetosis-related effects on an occupant on a vehicle seat, as well as to a vehicle seat.

During car journeys, receptors in the muscles do not report any motion to the brain, as the body is sitting substantially still on the vehicle seat. In contrast, the eyes report fast locomotion to the brain during the journey. In this case, the vestibular system in the inner ear provides information about a cornering or about accelerations and/or inclines, which contradicts the first messages. This flood of conflicting information leads to an overload, which the brain interprets as a dangerous situation. Consequently, stress hormones are released, which in turn cause symptoms, such as dizziness and/or nausea. Physical factors, such as anxious anticipation, can increase the symptoms. A starting point for countermeasures is therefore to reduce stress and/or avoid stress and/or to make information consistent with the journey. Unconventional or also unexpected passive movements can also be reduced. Programs for predicting and preventing kinetosis-related effects associated with secondary activities in the vehicle are already known from the prior art.

In this connection, for example, a method for reducing kinetosis-related effects on an occupant in a vehicle is disclosed from DE 10 2018 008 629 A1, in which at least one measure for targeted sensory stimulation of the occupant is initiated at the latest when kinetosis-related effects on the occupant are detected.

Alternatively, DE 10 2014 2016 161 A1 discloses a seat, in particular a motor vehicle seat, comprising at least one vibration element, which consists of a structure-borne sound generator. As an assistance and/or massage device, several vibration elements, each designed as a structure-borne sound generator, are arranged in a specifiable matrix in a seat part and/or in a backrest part of the seat.

Similarly, the programs for preventing nausea, such as for example “motion sickness prevention program”, are known in the prior art. In this program, the user is made aware of and can feel the vehicle motion in the dimensions of acceleration, steering and inclines by means of haptically and proprioceptively effective elements.

The seat systems act as a haptic information system for reducing sensory conflicts. The user, therefore, feels the acceleration, the steering, and the inclines via the seat system. The head position of the driver is schematically represented in a simplified manner on a display device (MBUX display), and the display device is equipped for information and feedback with the aim of minimizing movement. The driver in a highly automated means of transport is to be offered a mode, by means of which the driver or a front passenger or another occupant of the vehicle is supported in the event of nausea.

Consequently, exemplary embodiments of the invention are directed to a method by means of which a driver of the motor vehicle is offered support with kinetosis-related effects, as well as a vehicle seat.

A first aspect of the invention relates to a method for reducing kinetosis-related effects on an occupant on a vehicle seat in a motor vehicle, in particular in a passenger car, in particular in an at least semi-autonomous motor vehicle, in which at least one sequence of measures for targeted sensory stimulation of the occupant is initiated at the latest when a kinetosis-related effect on the occupant is detected. In other words, a signal for supporting the occupant is to be provided and transmitted to the corresponding entities when the kinetosis-related effect is detected. For example, a state of health of the occupant can be recorded via sensor devices, as well as via cameras, recording equipment, thermometers, heart rate monitors, and further components. In particular, for example, a heartbeat, facial perspiration, and/or further features indicating such kinetosis-related effects are to be recordable and/or recorded. For example, if the occupant feels nauseous, at least one measure is to be initiated to support the occupant in making them feel well again. For this purpose, at least one signal is transmitted, by the respective sensor device or by the components detecting the state of the occupant, to, for example, an electronic computing device for controlling the method, whereby, for example, initially an evaluation can be or is carried out and subsequently further components are at least partially controlled for prevention purposes or for supporting the occupant. In particular, this is to be provided at least partially automatically; in particular, it is provided according to the invention that the occupant receives the assistance they require in order to prevent nausea, dizziness or other conditions, in particular to avoid them completely, in the shortest possible time in the range of seconds, in particular in the millisecond range.

According to the invention, it is provided that the occupant is initially moved into a seat position leaning on a backrest of the vehicle seat, in which a head of the occupant is held in a specified support position by means of a headrest of the vehicle seat. In this case, it is provided that the vehicle seat can be adjusted, in particular the backrest is to be tilted, leaned or put backwards at a specified angle in the vehicle longitudinal direction in order to adjust the occupant into a lying position or into a leaning seat position; in particular, a calf support is to be folded up, leaned or moved forwards at a specified angle in the vehicle longitudinal direction, in particular analogous to the movement or adjustment of the backrest, whereby the leaning seat position of the vehicle seat can be or is adjusted for the entire body of the occupant. Furthermore, the headrest, which is fixedly connected to or held on the vehicle seat, in particular on the backrest, is to be designed to support the head of the occupant in a position, in particular in the support position. This support should be made possible, for example, by cushioned side bolsters of the headrest, for example by folding them together or folding them in the direction of the occupant's head, whereby the head is supported for a left and/or right movement in the longitudinal direction of the vehicle. In other words, the headrest is designed to avoid the left and right movement, or to support the head so that it is not shaken or flung about, in particular the headrest is also designed to cushion vibrations or to counteract acceleration only when required. However, it is to be considered that acceleration can also be supportive if the measures to reduce kinetosis-related effects provide for this. This means that the occupant can lie flat on their back or lean their back against the backrest and keep their head still or lean their head against a headrest and keep their head still against the latter. In particular, it is also possible to use cushions or automated cushions or other mechanical aids to keep the head still and to press the back as close as possible to the backrest.

Subsequently, as a further measure to reduce the kinetosis-related effects, the occupant is to be subjected to a cooling treatment by means of a cooling device. This means that heat must be dissipated, and the occupant is at least partially cooled. In particular, the dissipation of heat and cooling are intended to support vasoconstriction in order to counteract symptoms such as dizziness and nausea. In other words, the vehicle seat is provided with cooling devices and/or cooling means and/or cooling lines and/or other components for cooling or for controlling the temperature of the vehicle seat, in particular for controlling the temperature of and/or cooling a surface of the vehicle seat. In other words, the cooling means or cooling devices that can be used to carry out the respective cooling or temperature control according to specifications and the stature or other settings of the occupant are arranged on the vehicle seat at predetermined positions, points or surfaces. In particular, in addition to cooling, heating should also be possible, whereby heat can also be conducted to the occupant's body, in particular to their upper body. It is also intended, for example, to arrange thermometers and/or other sensor devices in order to control, in particular regulate, the at least partially automatic cooling treatment, and other means can also be used here, for example an air-conditioning system of the motor vehicle, which is coupled to the vehicle seat in such a way that cooling of a front side of the occupant is also made possible. Alternatively, further air channels or cooling device can be used which enable the cooling treatment for the occupant, in particular also cooling of the legs, the torso and the neck.

Again, subsequently, as a further measure for reducing the kinetosis-related effects, it is provided according to the invention that at least one sensory stimulation is carried out on at least one stimulation point. Sensory stimulation that at least partially stimulates the body of the occupant at this stimulation point is to be carried out by means of a stimulation element, which is arranged on the vehicle seat. In this case, in particular a massage or vibration is provided with stimulation of the sensors, wherein, for example, massage bubbles can be filled individually in the back or cushion and thus perform a massage on the body. These can be filled during defined processes so that the respective stimulation points perform respective massages. Alternatively, vibration motors can also be applied to the stimulation points, so that the sensory stimulation is represented by vibration, which in turn can be controlled individually. In this case, for example, all stimulation elements are electrically or electronically connected to an electronic computing device or a control device, which is designed to stimulate the respective stimulation points depending on the specifications. Therefore, it is possible to stimulate the body of the occupant at the specified stimulation points in such a way that the nausea and dizziness is counteracted.

Lastly, it is provided as a further measure that a journey of the motor vehicle is simulated by means of stimulation elements of the vehicle seat, depending on the detected kinetosis-related effects. In particular, the stimulation elements are to be designed in such a way that they simulate a movement, in particular an accelerating movement of the motor vehicle, in a plurality of the respective stimulation elements; in particular, automatic simulation of increased acceleration is to be simulated depending on the movements of the motor vehicle, whereby a discrepancy between motion sequences seen by the eyes of the occupant and a lack of a sensation of motion is counteracted. In other words, the vision of the occupant is supported by a simulation of the movement by the stimulation elements, wherein the stimulation elements may also be the massage bubbles that are inflated accordingly depending on the settings. In particular, a surface of the backrest, for example, can be provided with the massage bubbles, which are arranged to cover the surface or only a part of the surface; in other words, the backrest is covered by the massage bubbles and when the massage bubbles are inflated, a movement to the left and/or right can be or is simulated. In this case, the outermost massage bubbles are inflated more, in particular the most, in comparison to the opposite massage bubbles along the surface, in order to provide a linear decrease of the magnitude of the massage bubbles. In other words, the outermost massage bubbles are to be fully inflated on one side of the surface, while the massage bubbles are only slightly or not inflated at all on the other opposing side of the backrest. This leads to an inclined surface, which causes a slight rotation of the upper body of the occupant; alternatively, only half the surface of the backrest can be moved with the massage bubbles in such a way that only one side of the upper body of the occupant feels the rotation. Such inflation of the massage bubbles leads to a slight left and/or right acceleration of the upper body. Alternatively, a seat region of the vehicle seat can also be provided analogous to the backrest with the massage bubbles and take on the function, wherein a slight torsion with an axial direction in the vehicle longitudinal direction is possible. In other words, the occupant can be rotated and/or moved at least partially, so that an acceleration or movement of the motor vehicle can be felt or simulated. In particular, in this case, all models and/or options, which are offered by the vehicle seat, are to be controlled and/or regulated by an arranged electronic computing device.

Finally, the focus of the invention is to minimize sensory conflicts that can cause nausea or rather dizziness. Such prevention is conceived so that this motion sickness does not even occur in the first place. For this purpose, a massage system consisting of air-filled bubbles can be used in the backrest and/or cushion and/or hand, arm, foot or warning rest. Additionally, a pump, a control device and a valve block can be arranged. Possible expansions can be to install vibration motors in the cushion and/or backrest. It is also possible to include individual vibrations by using sound converters, for example, on the back. A processing unit, which calculates in advance, based on navigation information or the steering behavior of the driver or other parameters, which driving maneuver is to be carried out next or in which direction steering is to be performed, can use the information for preceding control of the components. This information, for example, “steer to the right”, is translated into a sequence of inflating massage bubbles in the backrest or seat cushion or footrest, which apply pressure to the body, for example the back or upper body and/or the legs or pelvis, in such a way that the body is set in motion in the direction in which the steering behavior also moves the body. In this manner, the sensory conflict is reduced or in the best case does not occur at all. If the vehicle is steered to the right, for example, the massage bubbles are filled in the left back region, so that the upper body is oriented to the right as in the driving direction. The more pronounced the curve, the more bubbles and therefore the more intensely these can be filled. Similarly, the massage bubbles can be filled on the right seat back side in order to support the feeling of turning to the left. The vibration motors in the cushion can be incorporated into this concept, in order to clarify the information.

In an advantageous embodiment of the invention, it is provided that in the leaning seat position, a visual fixed point is provided for the occupant. This means that a visual fixed point is offered to the occupant or the occupant is advised to fix a visual fixed point so that they can concentrate on this fixed point. Alternatively, a landscape can be displayed on the windscreen of the motor vehicle, on which the occupant can concentrate and in the ideal case has such a fixed point. In other words, a point, a position or an object is to be displayed to the occupant, for example, on the windscreen or on a further surface, in particular a fixed point that is as visible as possible is displayed, which requires the concentration of the occupant as an observer and at least partially calms them or counteracts the kinetosis-related effects.

Similarly, an embodiment of the invention is advantageous in which at least one message is displayed to the occupant for calming purposes. In this case, a display device of the motor vehicle can be used to report to the occupant to lean back, to keep their head still, to relax, etc. In particular, help is to be provided not only through simulation, but also through psychological support by showing the occupant through the display device that support is actively taking place. In particular, the display device has a display surface on which a warning signal, a calming notification or a relaxing animation or video is shown which counteracts the kinetosis-related effects. Alternatively, functions can be shown which the occupant can select and carry out in order to counteract their values measured by the sensor devices.

In a further advantageous embodiment of the invention, it is provided that the occupant is subjected to at least one second cooling treatment by means of the cooling device, which is carried out according to the invention after simulating the journey by the motor vehicle seat. Therefore, cooling is further maintained or restarted, whereby dizziness and nausea of the occupant are eased. In particular, the sympathetic nervous system and the parasympathetic nervous system are to be stimulated for the benefit of the occupant, and thus in particular to have an influence on and thus reinforce the parasympathetic part of the nervous system.

Lastly, in a further advantageous embodiment of the invention, it is provided that auditory and visual settings of an interior of the motor vehicle are adjusted. In this case, both lighting effects as well as light insulation can be used, and settings of the auditory surroundings can be changed, for example by switching on calming music. Therefore, it is possible to offer the occupant an interior in which they can relax particularly well.

A further aspect of the invention relates to a vehicle seat for a motor vehicle with all the features for carrying out a method for reducing kinetosis-related effects on an occupant on the vehicle seat.

In other words, it is possible by means of the invention to support an occupant with nausea and dizziness. In this case, information about inclines, direction changes and acceleration is detected in a processing unit by an electronic computing device. This is detected, for example, by the information on steering angle changes, navigation information from the route plan, activity at the accelerator pedal and information from altimeters. Based on this, processes and patterns of functions of the components are created in the vehicle seat, which limit the corresponding vehicle movements for the body. The information on vehicle movement, for example steering to the right or the left, acceleration in, for example, three stages and an incline in, for example, three stages is gathered and processed. Based on this, patterns for controlling components are created and are transferred to the components. Such components can be the fan, a driving dynamics function, processes of dynamic comfort systems, such as massages and vibration motors. These are controlled depending on the pattern in such a way that dizziness and nausea of the occupant are reduced. The more extreme, faster or steeper the journey is, the more components a pattern has to receive, and have to be controlled according to this pattern. Such dynamic activation of the patterns can be carried out depending on the dimensions of vehicle movement from when the program starts to when the program ends. A period can be selectively adjusted by the occupant, for example. Here, for example, 10 minutes can be set as the default. Parallel information for stabilizing head positions and body positions can be displayed on a display device, this information having been previously detected via a camera system for driver observation.

Further advantages, features and details of the invention can be seen from the following description of a preferred exemplary embodiment and with reference to the drawing. The features and combinations of features mentioned above in the description as well as the features and combinations of features mentioned below in the description of the FIGURE and/or shown alone in the single FIGURE can be used not only in the combination indicated in each case, but also in other combinations or on their own, without leaving the scope of the invention.

### BRIEF DESCRIPTION OF THE SOLE DRAWING FIGURE

The sole drawing FIGURE shows a vehicle seat 10 according to the invention for a motor vehicle with all the features for carrying out a method for reducing kinetosis-related effects on an occupant.

### DETAILED DESCRIPTION

The sole drawing FIGURE shows a vehicle seat 10 for a motor vehicle in which at least one sequence of measures for targeted sensory stimulation of the occupant is initiated when kinetosis-related effects on the occupant are detected, which is not shown in the FIGURE. In this case, the occupant is moved into a seat position S leaning on a backrest 12 of the vehicle seat, in which a head of the occupant is held in a specified support position by a headrest 14 of the vehicle seat. Thereafter, the occupant is subjected to a partial cooling treatment, wherein at least one cooling device 16 designed to at least partially cool regions of the body of the occupant is arranged both in the backrest 12 as well as the headrest 14. Alternatively, a heating device 20 is also arranged for a heat treatment. A plurality of stimulation elements 18 are arranged on the vehicle seat 10, in particular on the backrest 12 and on a seat part 13, by means of which stimulation elements sensory stimulation is carried out on at least one stimulation point P. In particular, this stimulation element 18 is designed as an air bubble which is at least partially inflated and deflated, as specified, by means of a control device, not shown in the sole FIGURE. A journey of the motor vehicle can be simulated depending on the detected kinetosis-related effects by means of the stimulation elements 18.

It is possible to display at least one fixed point in the interior of the motor vehicle, which is not represented in the sole FIGURE, so that the occupant can concentrate on this fixed point during the method. Similarly, it is possible to display at least one message to the occupant for calming purposes using its similarly not shown display device, the message telling the occupant to calm down. Lastly, it is possible to also design an auditory and visual setting in the interior in such a way that the occupant can relax inside the interior 24.

A journey of the motor vehicle is simulated, depending on the detected kinetosis-related effects, by means of the stimulation elements 18 of the vehicle seat 10. In particular, the stimulation elements 18 are designed as massage bubbles, wherein in a plurality of the respective stimulation elements 18, a movement, in particular an accelerating movement of the motor vehicle is simulated; in particular, automatic simulation of increased acceleration is to be simulated depending on the movements of the motor vehicle, whereby a discrepancy between motion sequences seen by the eyes of the occupant and a lack of a sensation of motion is counteracted. In other words, vision of the occupant is supported by a simulation of the movement by the stimulation elements 18, wherein the stimulation elements 18 are the massage bubbles that are inflated accordingly depending on the settings.

In particular, a surface of the backrest 12, for example, can be provided with the massage bubbles, which are arranged to cover the surface or only a part of the surface; in other words, the backrest 12 is covered by the massage bubbles and when the massage bubbles are inflated, a movement to the left and/or right can be or is simulated. In this case, the outermost massage bubbles are inflated more, in particular the most, in comparison to the opposite massage bubbles along the surface, in order to provide a linear decrease of the magnitude of the massage bubbles. In other words, the outermost massage bubbles are to be fully inflated on one side of the surface, while the massage bubbles are only slightly or not inflated at all on the other opposing side of the backrest 12. This leads to an inclined surface, which causes a slight rotation of the upper body of the occupant; alternatively, only half the surface of the backrest 12 can be moved with the massage bubbles in such a way that only one side of the upper body of the occupant feels the rotation. Such inflation of the massage bubbles leads to a slight left and/or right acceleration of the upper body, wherein the massage bubbles are designed to move the upper body with a specified force F in a specified acceleration. Alternatively, a seat region of the vehicle seat 10 can also be provided analogous to the backrest 12 with the massage bubbles and take on the function, wherein a slight torsion with an axial direction in the vehicle longitudinal direction is possible. In other words, the occupant can be rotated and/or moved at least partially, so that an acceleration or movement of the motor vehicle can be felt or simulated. In particular, in this case, all models and/or options, which are offered by the vehicle seat 10, are to be controlled and/or regulated by an arranged electronic computing device.

In order to support an occupant with nausea and dizziness, the seat part 13 can be used in addition to the backrest 12, wherein information about inclines, direction changes and acceleration is detected in a processing unit by an electronic computing device. This is detected, for example, by the information on steering angle changes, navigation information from the route plan, activity at the accelerator pedal, and information from altimeters. Based on this, processes and patterns of functions of the backrest 12 and the seat part 13 are created in the vehicle seat, which limit the corresponding vehicle movements for the body. The information on vehicle movement, for example steering to the right or the left, acceleration in, for example, three stages and an incline in, for example, three stages is gathered and processed. Based on this, patterns for controlling the backrest 12 and the seat part 13 are created and transferred. For example, processes of dynamic comfort systems, such as massages and vibrations 22, are performed by vibration motors. These are controlled depending on the pattern in such a way that dizziness and nausea of the occupant are reduced.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for reducing kinetosis-related effects on an occupant on a vehicle seat in an interior of a motor vehicle, the method comprising:
detecting a kinetosis-related effect on the occupant; and
initiating, responsive to detecting the kinetosis-related effect on the occupant, at least one sequence of measures for targeted sensory stimulation of the occupant, wherein the least one sequence of measures for targeted sensory stimulation of the occupant comprises
moving the occupant into a seat position leaning on a backrest of the vehicle seat, in which a head of the occupant is held in a specified support position by a headrest of the vehicle seat;
partially subjecting the occupant to a cooling treatment by a cooling device of the vehicle seat;
performing at least one sensory stimulation on at least one stimulation point of the occupant; and
simulating a journey of the motor vehicle depending on the detected kinetosis-related effect by stimulation elements of the vehicle seat.

8. The method of claim 7, wherein when the occupant is moved into the seat position leaning on the backrest, a visual fixed point is provided for the occupant.

9. The method of claim 7, further comprising
displaying at least one message to the occupant.

10. The method of claim 7, wherein the occupant is subjected to at least one second cooling treatment by the cooling device.

11. The method of claim 7, wherein auditory and visual settings of the interior of the motor vehicle are modified.

12. A vehicle seat for a motor vehicle, the vehicle seat comprising:
a headrest;
a seat part;
a backrest arranged between the headrest and the seat part,
a cooling device; and
stimulation elements,
wherein the vehicle seat is configured to initiate, responsive to detecting a kinetosis-related effect on an occupant of the vehicle seat, at least one sequence of measures for targeted sensory stimulation of the occupant, wherein the least one sequence of measures for targeted sensory stimulation of the occupant comprises
moving the occupant into a seat position leaning on the backrest, in which a head of the occupant is held in a specified support position by the headrest;
partially subjecting the occupant to a cooling treatment by the cooling device;
performing at least one sensory stimulation on at least one stimulation point of the occupant; and
simulating a journey of the motor vehicle depending on the detected kinetosis-related effect by the stimulation elements.
